(19) United States
(12) Patent Application Publication
(10) Pub. No.: US 2008/0237196 A1
(43) Pub. Date: Oct. 2, 2008

(54) CONSUMABLE ELECTRODE TYPE GAS SHIELDED ARC WELDING CONTROL APPARATUS AND WELDING CONTROL METHOD

(75) Inventors: Kei YAMAZAKI, Fujisawa-shi (JP); Eiji Sato, Fujisawa-shi (JP); Shogo Nakatsukasa, Fujisawa-shi (JP); Masahiro Honma, Fujisawa-shi (JP); Keiichi Suzuki, Fujisawa-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Kabushiki Kaisha Kobe Seiko Sho (Kobe Steel Ltd.), Kobe-shi (JP)

(21) Appl. No.: 12/027,526

(22) Filed: Feb. 7, 2008

(30) Foreign Application Priority Data
Mar. 29, 2007 (JP) 2007-089898

(51) Int. Cl. B23K 9/173; B23K 9/09

(52) U.S. Cl. 219/74

(57) ABSTRACT

In consumable electrode type gas shielded arc welding, a time second order differential value of a welding voltage or an arc resistance is calculated. Based on the second order differential value, a detachment of a droplet or a timing just before the detachment is detected. After the droplet detachment or the timing just before the detachment is detected, a welding current value is immediately switched to a predetermined current value lower than that at the time of the detection. According to the control, even if welding conditions are changed or wire extension lengths are changed in the welding, the droplet detachment can be correctly detected.

### BACKGROUND OF THE INVENTION

1. Field of the Invention

The present invention relates to a consumable electrode type gas shielded arc welding control apparatus for performing arc welding using consumable electrodes in a shielding gas atmosphere and a method for controlling the welding.

2. Description of the Related Art

In consumable electrode type gas shielded arc welding, as an electrode wire deteriorates, a droplet is formed at the wire tip. The droplet grows under influence of various forces such as gravity, arc reaction force, electromagnetic pinch force, and surface tension. Then, the droplet is detached and transferred to a molten pool. However, the growth process is very unstable. If the droplet is excessively pushed up and deformed, the droplet is detached under the influence of the arc resistance force without transferring to the molten pool in a wire extension direction, and diffuses as large-sized spatters. Accordingly, the droplet transfer cycle becomes irregular, influences the behavior of the molten pool to be irregular, and the above-described phenomenon is facilitated. Moreover, after the detachment of the droplet, when the arc moves to the wire, the melt remaining at the wire tip is blown off, and small-sized spatters are formed. This spatter generation phenomenon often occurs especially in middle/high current welding using carbon dioxide gas as a single substance or mixed gas including the carbon dioxide gas as shielding gas. The spatters deteriorate quality of welding structures.

To solve the problem, U.S. Pat. No. 5,834,732 discloses an output control apparatus for pulse arc welding using shielding gas mainly composed of carbon dioxide gas. In the known art, droplet detachment is detected based on an increase in voltage or resistance and spatters are controlled by lowering a current for a certain period from the detection. More specifically, in the known art, the detection voltage or the detection resistance is compared with a reference voltage or a reference resistance, and if the detection voltage or the detection resistance exceeds the reference voltage or the reference resistance, a detection signal is outputted, or, if a differential value of the detection voltage or the detection resistance exceeds a set value, the detection signal is outputted.

However, in the control apparatus and method of the above known art, it is not possible to correctly detect the droplet detachment if welding conditions are changed during the welding and if wire extension lengths are changed (for example, weaving welding in a groove). Such detection errors often occur in high current regions. Accordingly, in the high current regions where spatter reduction is especially desired, the spatters are not reduced, and on the contrary, the detection errors increase the spatters. As a result, the quality of the welding structures may be deteriorated.

Further, generally, voltage levels and the slopes at droplet detachment differ in each droplet transfer. In a case where a certain reference value for comparison is set in advance, if the reference value is set to a relatively small value, detection errors are highly possible. Accordingly, it is required to set the reference value for comparison to a relatively large value, and determine droplet detachment after the droplet detachment based on a large increase of an arc length when the arc transfers from the droplet to the wire. That is, according to the known art, the waveform is controlled after the droplet is completely detached. In this case, at the moment the arc immediately after the droplet detachment transfers to the wire, the current value is still at the high current value at the detachment. Accordingly, it is not possible to solve the problem that the melt remaining at the wire tip is blown off and the small-sized spatters are generated. Further, even if the method is used, the detection errors of the droplet detachment cannot be appropriately prevented.

### SUMMARY OF THE INVENTION

Accordingly, the present invention has been made in view of the above, and it is an object of the present invention to provide a welding control apparatus and welding control method capable of correctly detecting droplet detachment even if welding conditions are changed during the welding or wire extension lengths are changed (for example, in weaving welding). Further, depending on setting of a predetermined reference value for comparison, a timing just before the droplet detachment can be detected. Based on the droplet detachment detection, by switching the current to a current lower than that at the time of the detection, spatter generation in a middle/high current region can be reduced and quality of welding structures can be improved.

According to an aspect of the present invention, a welding control apparatus for controlling a welding current in consumable electrode type gas shielded arc welding is provided. The welding control apparatus includes a calculation part for calculating a time second order differential value d²V/dt² of a welding voltage in welding, or a time second order differential value d²R/dt² of an arc resistance in welding; a detection section for detecting a detachment of a droplet or a timing just before the detachment if the value calculated by the calculation part exceeds a predetermined threshold and outputting a droplet detachment detection signal; a waveform generator for controlling a welding power supply waveform after the droplet detachment based on the droplet detachment detection signal; and an output control part for outputting a welding current according to a waveform control signal outputted from the waveform generator. The waveform generator outputs the waveform control signal to the output control part in response to the input of the droplet detachment detection signal so that the welding current value becomes lower than that at the time of the detection for a predetermined term. The arc resistance is obtained by dividing the welding voltage by the welding current.

The threshold set to the detection section is appropriately set based on an observation using a high-speed camera and a waveform synchronous measurement test by calculating the second order differential value using the calculation part in the droplet detachment phenomenon. The detection section compares the second order differential value calculated by the calculation part with the threshold to detect the droplet detachment.

According another aspect of the present invention, a welding control method for welding performed using a consumable electrode type gas shielded arc welding method is provided. The welding control method includes calculating a time second order differential value d²V/dt² of a welding voltage in a gas shielded arc welding, or a time second order differential value d²R/dt² of an arc resistance in the welding; detecting a detachment of a droplet or a timing just before the detachment if the value calculated in the calculation exceeds a predetermined threshold; and switching a welding current value to a current value lower than that at the time of the detection after the detection of the droplet detachment or the timing just before the detachment.

Preferably, the welding current and the welding voltage have pulse waveforms, and using an electromagnetic pinch force by the pulses, the droplet is detached.

Preferably, CO₂ gas is used for a shielding gas.

According to embodiments of the present invention, using a second order differential value of a welding voltage or an arc resistance, a detachment of a droplet or a timing just before the droplet detachment is detected. After the detection of the droplet detachment or the timing just before the droplet detachment, a current is immediately switched to a lower current than the current at the time of the droplet detachment. Accordingly, even if welding conditions are changed during the welding or wire extension lengths are changed (for example, in weaving welding), the droplet detachment can be correctly detected. Further, depending on setting of a predetermined reference value for comparison, it is possible to detect a timing just before the droplet detachment. After the droplet detachment detection, by switching the current to a predetermined current lower than that at the time of the detection, spatter generation in a middle/high current region can be largely reduced and quality of welding structures can be improved.

### BRIEF DESCRIPTION OF THE DRAWINGS

FIGS. 1A to 1C are views illustrating a principle of the present invention;

FIG. 2 is a block diagram illustrating a welding control apparatus according to a first embodiment of the present invention;

FIG. 3 is a block diagram illustrating a welding control apparatus according to a second embodiment of the present invention;

FIGS. 4A and 4B are graphs illustrating welding current waveforms, welding voltage waveforms, time second order differential values of the welding voltage d²V/dt², time second order differential values of arc resistance d²R/dt², and detachment detection signal waveforms according to the first embodiment of the present invention;

FIGS. 5A and 5B are graphs illustrating welding current waveforms, welding voltage waveforms, time second order differential values of the welding voltage d²V/dt², and detachment detection signal waveforms according to the second embodiment of the present invention;

FIG. 6 is a view illustrating a pulse waveform; and

FIG. 7 is a graph illustrating detachment detection success rates on all droplet transfer per ten seconds in welding.

### DESCRIPTION OF THE PREFERRED EMBODIMENTS

When a droplet is detached, a root of the droplet existing at a wire tip is constricted and as the constriction proceeds, welding voltage and resistance increases. Further, when the droplet is detached, an arc length becomes long, and the welding voltage and resistance increases. Accordingly, time differential values of these values also increase. While the droplet starts to be constricted and detached, the welding voltage and resistance and these differential values always increase. Accordingly, in known arts, to determine droplet detachment, these values are detected and calculated and the results are compared with predetermined thresholds.

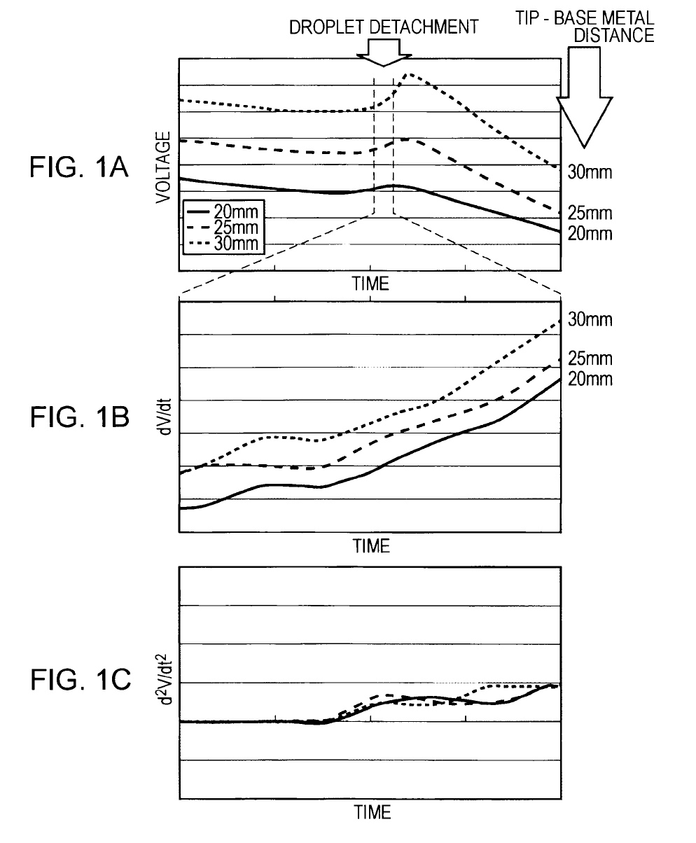

However, in the droplet detachment determination based on the measured values of the welding voltage and resistance or their differential values, if welding conditions are changed or wire extension lengths are changed (for example, in weaving welding in a groove) while the welding is being performed, it is not possible to correctly detect the droplet detachment. For example, FIG. 1A illustrates a voltage change at droplet detachment in a case where wire extension lengths, that is, tip-base metal distances are changed in welding. If the tip-base metal distance is short, the voltage rise is slow and if the tip-base metal distance is long, the voltage rise is steep. Moreover, the voltage value levels themselves differ from each other. Accordingly, time differential values (dv/dt) of the voltage differ from each other as shown in FIG. 1B. It is similar to the above in a case of arc resistance. That is, in a case where wire extension lengths are changed in welding, the change in the voltage or the change in the arc resistance due to the droplet detachment overlaps with the change in the voltage or the change in the arc resistance due to the change of the extension lengths. Accordingly, it is not possible to correctly detect the droplet detachment using a same determination reference. Further, similarly, in the case where the welding conditions such as the current or voltage are changed in welding, it is not possible to correctly detect the droplet detachment by the method that uses the voltage values and the arc resistance value levels or their time differential vales.

On the other hand, the slopes of the segments shown in FIG. 1B, that is, second order differential values of the welding voltage or the arc resistance are substantially same values as shown in FIG. 1C. The second order differential values are not largely influenced by the welding conditions such as the wire extension lengths. According to embodiments of the present invention, the time second order differential values of the welding voltage or the arc resistance in welding are calculated, droplet detachment or a timing just before the droplet detachment is detected, and the welding current immediately after the detection is controlled to be a low current. Accordingly, correct droplet detachment can be performed without the influence of the change in the welding conditions in welding.

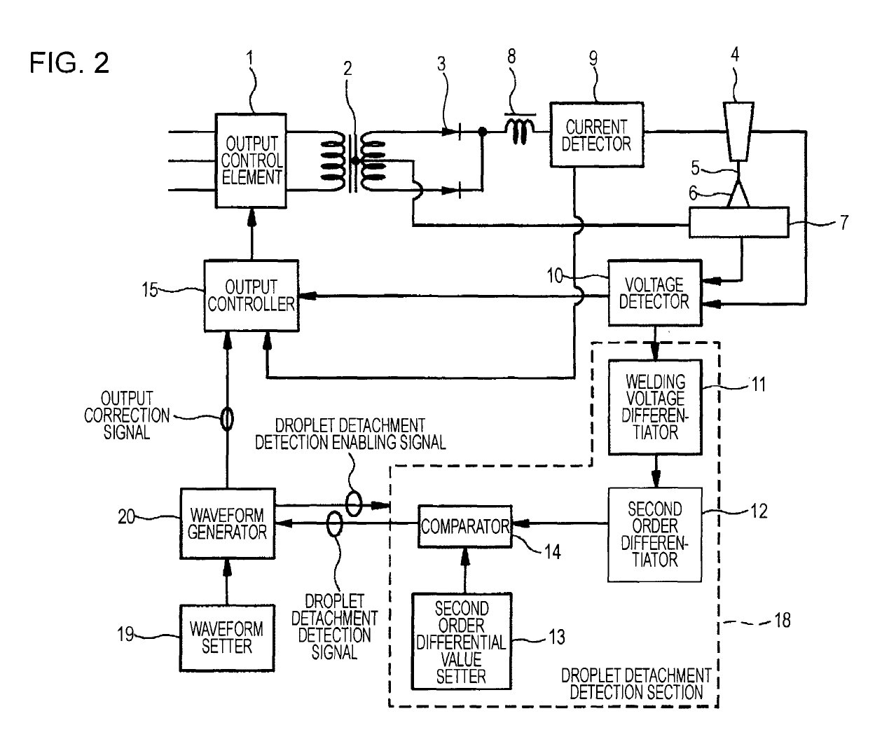

Hereinafter, specific structures of the welding control apparatus according to embodiments of the present invention will be described. FIG. 2 is a block diagram illustrating a welding control apparatus according to a first embodiment of the present invention. In the first embodiment, a time second order differential value of a welding voltage is used. An output control element 1 is connected to a three-phase alternator (not shown). A current given to the output control element 1 is supplied to a contact tip 4 through a rectifying part 3 including a transformer 2 and a diode, a direct-current reactor 8, and a current detector 9 that detects a welding current. A material to be welded 7 is connected to a lower power supply side of the transformer 2. A welding arc 6 is generated between a welding wire 5 that is inserted through the contact tip 4 and to which the power is supplied and the material to be welded 7.

A welding voltage between the contact tip 4 and the material to be welded 7 is detected by a voltage detector 10 and inputted into an output controller 15. To the output controller 15, further, a detection value of a welding current is inputted from the current detector 9. The output controller 15 controls a welding current and a welding voltage to supply to the wire 5 based on the welding voltage and the welding current.

The welding voltage detected by the voltage detector 10 is inputted into a welding voltage differentiator 11 of a droplet detachment detection section 18, and in the welding voltage differentiator 11, a time first order differential value is calculated. Then, the first order differential value of the welding voltage is inputted into a second order differentiator 12. In the second order differentiator 12, a time second order differential value of the welding voltage is calculated. The time second order differential value is inputted into a comparator 14. In a second order differential value setter 13, a second order differential set value (threshold) is inputted and set. The comparator 14 compares the second order differential value from the second order differentiator 12 with the set value (threshold) from the second order differential value setter 13. At a moment when the second order differential value exceeds the set value, a droplet detachment detection signal is outputted. It is determined that the moment when the second order differential value exceeds the set value is the time when the droplet is detached from the wire tip or the timing just before the detachment.

The droplet detachment detection signal is inputted into a waveform generator 20. In the waveform generator 20, a welding current waveform after the droplet detachment is controlled and an output correction signal is inputted into the output controller 15. In response to the input of the droplet detachment detection signal, the waveform generator 20 outputs a control signal (output correction signal) to the output controller 15 so that the welding current value is lower than that at the time of the detection during a term set by the waveform generator 20. A waveform setter 19 is used to input a degree of the term for outputting the output correction signal and a degree to lower the welding current in the waveform generator 20. By the waveform setter 19, the degree of the term for outputting the output correction signal and the degree to lower the welding current are set to the waveform generator 20.

The droplet detachment detection signal is outputted when a detachment of a droplet or a timing just before the droplet detachment is detected. In the droplet detachment, a root of the droplet existing at a wire tip is constricted and as the constriction proceeds, the welding voltage and the resistance increase. Further, when the droplet is detached, the arc length becomes long, and the welding voltage and resistance increase. In a case where the increase is detected using the voltage and the resistance value or the differential values of the values, if welding conditions are changed in welding, the change in the welding conditions influences the droplet detachment detection section to frequently perform erroneous detection and increase spatters. However, in the detection using the second order differential values according to the embodiment of the present invention, even if welding conditions are changed in welding, the detection is not influenced by the change in conditions, it is possible to correctly detect the droplet detachment. Further, if a second order differential value corresponding to the change in the voltage or the arc resistance due to the constriction just before the droplet detachment is set using the second order differential value setter 13, the timing just before the droplet detachment can be detected and the welding waveform can be controlled. Accordingly, the problem that the melt remaining at the wire tip is blown off and small-sized spatters are generated can be substantially solved.

Now, an output correction after the detection of the droplet detachment or the timing just before the droplet detachment is described. First, parameters such as a current and a voltage necessary for the correction are set using the waveform setter 19. The output controller 15 inputs signals sent from the current detector 9, the voltage detector 10, and the waveform generator 20 and controls the output control element 1 to control an arc. In a case where a droplet detachment detection signal is not inputted to the waveform generator 20, the output controller 15 outputs a control signal to the output control element 1 so that the detected current detected by the current detector 9 and the detected voltage detected by the voltage detector 10 are to be the current and voltage set by the waveform setter 19. After the waveform generator 20 inputted the droplet detachment detection signal of the droplet detachment detection section 18, the waveform generator 20 outputs an output correction signal to the output controller 15 so that during a term set by the waveform setter 19, the welding current is to be the welding current set by the waveform setter 19. The welding current at the time is lower than that at the detection. Accordingly, the arc reaction force pushing up the droplet becomes weak, and the droplet transfers to a molten pool without largely diverging from a wire extension direction. Accordingly, the droplet is hardly diffused as spatters.

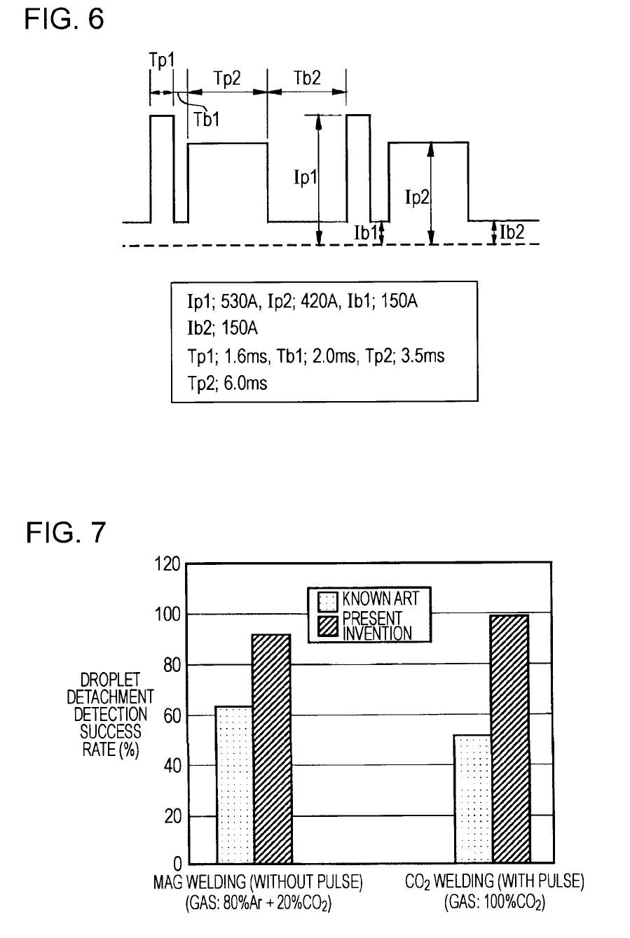

Now, a case where a welding current and a welding voltage have pulse waveforms and a droplet is detached using an electromagnetic pinch force by the pulses is described. FIG. 6 illustrates an example of the pulse waveforms. Using the waveform setter 19, necessary parameters such as pulse peak currents (Ip1, Ip2), pulse widths (Tp1, Tp2, Tb1, Tb2), base currents (Ib1, Ib2) are set. The output controller 15 inputs signals sent from the current detector 9, the voltage detector 10, and the waveform generator 20, and controls the output control element 1 to control a pulse arc. The droplet detachment detection section 18 enables a droplet detachment detection only within a term a droplet detachment enabling signal in inputted from the waveform generator 20. In a case where a droplet detachment detection signal is not inputted to the waveform generator 20, the output controller 15 outputs a control signal to the output control element 1 so that the detected current detected by the current detector 9 and the detected voltage detected by the voltage detector 10 are to form the pulse waveform set by the waveform setter 19. In a case where the droplet detachment detection signal is inputted to the waveform generator 20, the waveform generator 20 outputs an output correction signal to the output controller 15 so that during the term set by the waveform setter 19, the welding current is to be the welding current set by the waveform setter 19. The welding current at the time is lower than that at the detection. Accordingly, the droplet is hardly diffused as spatters. In response to the expiration of the output correction term set by the waveform setter 19, the output controller 15 controls the current and voltage so that the pulse waveform set by the waveform setter 19 is formed.

In the case of the droplet detachment using the electromagnetic pinch force by the pulses, if a mixed gas composed of an inert gas such as Argon as a base is used for a shielding gas, one droplet transfers per one pulse. Then, the droplet detachment detection can be performed during a term from a pulse peak term to a slope term in transferring from the peak term to a base term in all pulse term. If 100% CO₂ is used for the shielding gas, two pulse waveforms having different pulse peak currents and pulse widths are alternately outputted. The two pulse waveforms function to detach a droplet and to form a droplet respectively. In this case, similar to the droplet detachment using the mixed gas, the droplet detachment detection can be performed during the term from the pulse peak term to the slope term in transferring from the peak term to the base term of the pulse that detaches the droplet.

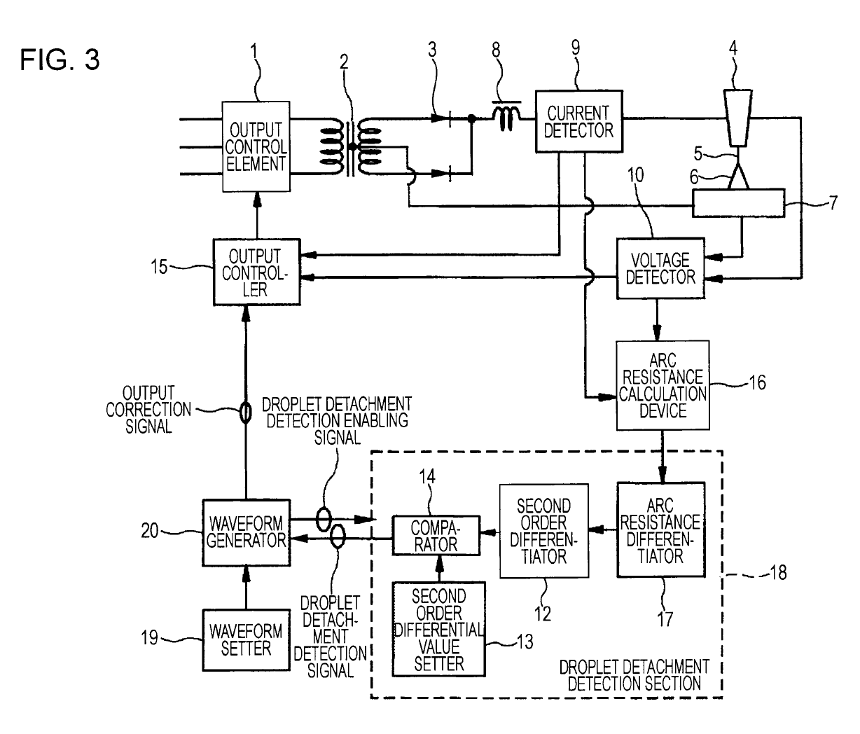

FIG. 3 is a block diagram illustrating a welding control apparatus according to a second embodiment of the present invention. In the second embodiment, the droplet detachment detection section 18 includes, in place of the welding voltage differentiator 11, an arc resistance differentiator 17. Outputs from the voltage detector 10 and the current detector 9 are inputted to an arc resistance calculation device 16. The arc resistance calculation device 16 calculates an arc resistance by dividing the voltage by the current. The calculated value of the arc resistance is inputted to the arc resistance differentiator 17, and first differentiated by the arc resistance differentiator 17. Then, the first differentiated value is differentiated into the second order differentiated value of the arc resistance by the second order differentiator 12. The second order differential value of the arc resistance is compared with a second order differential set value (threshold) inputted from the second order differential value setter 13 by the comparator 14. At a moment when the second order differential value of the arc resistance exceeds the set value, a droplet detachment detection signal is outputted.

The second embodiment achieves similar effects to the first embodiment shown in FIG. 2.

### EXAMPLES

Now, results of welding tests for exemplifying the effects according to the embodiments of the present invention are described.

### Example 1

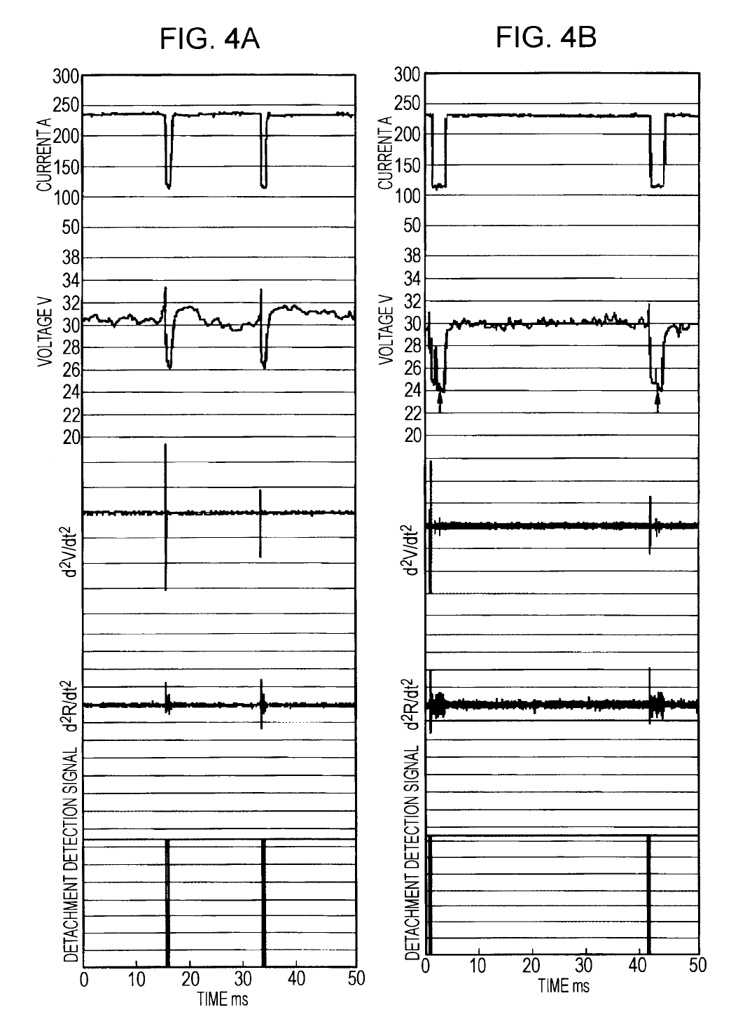

A gas shielded arc welding was performed using the welding control apparatuses according to the first and second embodiments shown in FIGS. 2 and 3, a solid wire of 1.2 mm in wire diameter for a consumable electrode wire, MAG (80% Ar+20% CO₂) gas for a shielding gas. FIGS. 4A and 4B illustrate welding current waveforms, welding voltage waveforms, time second order differential values of the welding voltage d²V/dt², time second order differential values of arc resistance d²R/dt², and detachment detection signal waveforms at the time. Welding conditions were set as an average current of 240 A, an average voltage of 30 to 32 V, a welding speed of 30 cm per minute, and a wire extension length of 25 mm.

FIG. 4A illustrates that in response to a change in d²V/dt² or d²R/dt² , and immediately after a detachment detection signal was outputted, a welding current was switched to 120 A, and after 2.0 ms passed, the welding current returned to an original current (240 A). FIG. 4B illustrates an example that a timing just before a droplet detachment was detected. In response to a change in d²V/dt² or d²R/dt², and immediately after a detachment detection signal was outputted, a welding current was switched to 120 A, and after 7.0 ms passed, the welding current returned to an original current (240 A). As indicated by an arrow in the voltage waveform, it is understood that the droplet detachment was performed after the welding current was switched to 120 A.

### Example 2

A pulse arc welding was performed using the welding control apparatuses according to the first and second embodiments, a solid wire of 1.2 mm in wire diameter for a consumable electrode wire, CO₂ for a shielding gas.

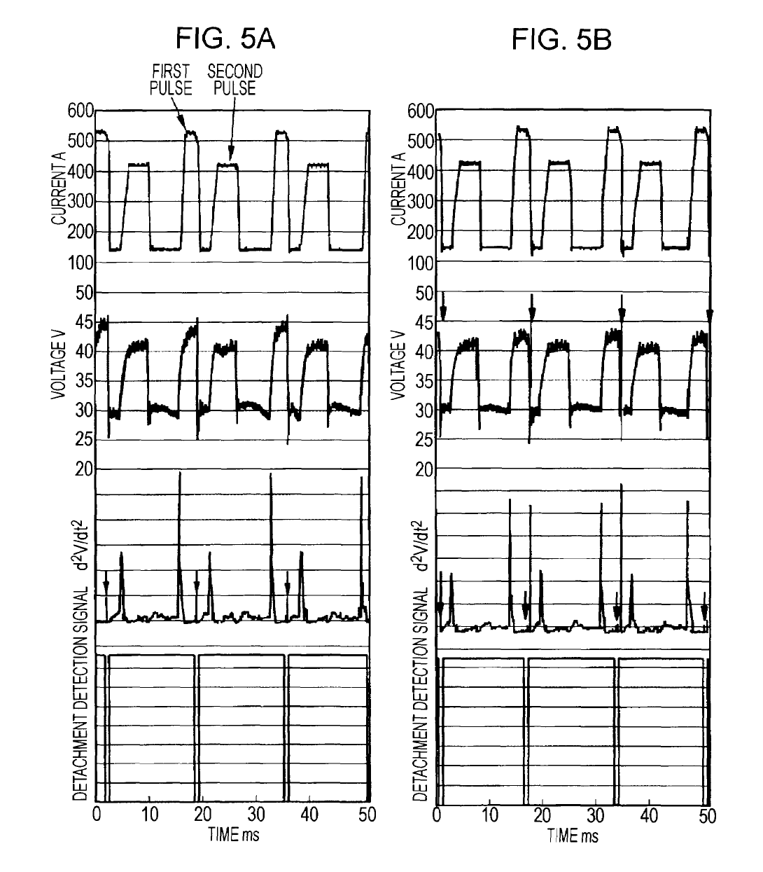

FIGS. 5A and 5B illustrate welding current waveforms, welding voltage waveforms, time second order differential values of the welding voltage d²V/dt², and detachment detection signal waveforms in the welding. FIG. 6 illustrates the pulse waveform. As illustrated in FIG. 6, one droplet transfer per one cycle was realized by alternately outputting two pulse waveforms having different pulse peak currents Ip1 and Ip2, and pulse widths Tp1 and Tp2, detaching a droplet at a first pulse (Ip1, Tp1) in FIG. 5A, and forming a droplet at a second pulse (Ip2, Tp2) in FIGS. 5A and 5B. In a peak term or a trailing slope term of the first pulse, a droplet detachment enabling signal was outputted, and immediately after a droplet detachment or a timing just before the droplet detachment was detected, the current was switched to a predetermined current that was lower than that at the detection. In this example, welding conditions were set as an average current of 300 A, an average voltage of 35 to 36 V, a welding speed of 30 cm per minute, and a wire extension length of 25 mm. FIG. 5A illustrates that in response to changes in d²V/dt² (indicated by arrows), and immediately after detachment detection signals were outputted, a welding current was switched to 150 A that was lower than the value at the detection. FIG. 5B illustrates an example that a timing just before a droplet detachment was detected. As indicated by arrows in the voltage waveform, it is understood that the droplet detachment was performed after the current was switched to 150 A that was lower than the current value at the detection.

### Example 3

A gas shielded arc welding using the welding control apparatuses shown in FIGS. 2 and 3, a solid wire of 1.2 mm in wire diameter for a consumable electrode wire, MAG (80% Ar+20% CO₂) gas for a shielding gas, and a pulse arc welding using a 100% CO₂ gas were performed. In flat position fillet welding, droplet detachment detection success rates in a known art (detection using time differential values dV/dt of voltage) and the present invention (detection using time second order differential values d²V/dt² of voltage) were compared with each other. In the flat position fillet welding, the welding was performed under conditions of a weaving width of 6.0 mm, and a weaving frequency of 2 Hz, and wire extension lengths were momentarily changed. An average voltage was set to 300 A, voltage was set to appropriate voltage corresponding to each shielding gas, and a welding speed and a wire extension length were set to the same values as those of the first and second embodiments. Using a high-speed camera image and synchronous measurement of current waveforms, voltage waveforms, and detachment detection signal waveforms, the detachment detection success rates were calculated with respect to all droplet transfer per ten seconds in the welding. FIG. 7 illustrates the results of the detachment detection. In both welding methods of the gas shielded arc welding using the MAG (80% Ar+20% CO₂) gas and the pulse arc welding using the 100% CO₂ gas for the shielding gas, the detachment detection success rates were largely improved according to the embodiments of the present invention.

What is claimed is:

1. A welding control apparatus for controlling a welding current in consumable electrode type gas shielded arc welding, the welding control apparatus comprising:
a calculation part for calculating a time second order differential value d²V/dt² of a welding voltage in welding, or a time second order differential value d²R/dt² of an arc resistance in welding;
a detection section for detecting a detachment of a droplet or a timing just before the detachment if the value calculated by the calculation part exceeds a predetermined threshold and outputting a droplet detachment detection signal;
a waveform generator for controlling a welding power supply waveform after the droplet detachment based on the droplet detachment detection signal; and
an output control part for outputting a welding current according to a waveform control signal outputted from the waveform generator,
wherein the waveform generator outputs the waveform control signal to the output control part in response to the input of the droplet detachment detection signal so that the welding current value becomes lower than that at the time of the detection for a predetermined term.

2. The welding control apparatus according to claim 1, wherein the welding current and the welding voltage have pulse waveforms, and using an electromagnetic pinch force by the pulses, the droplet is detached.

3. A welding control method for welding performed using a consumable electrode type gas shielded arc welding method, the welding control method comprising:
calculating a time second order differential value d²V/dt² of a welding voltage in a gas shielded arc welding, or a time second order differential value d²R/dt² of an arc resistance in the welding;
detecting a detachment of a droplet or a timing just before the detachment if the value calculated in the calculation exceeds a predetermined threshold; and
switching a welding current value to a current value lower than that at the time of the detection after the detection of the droplet detachment or the timing just before the detachment.

4. The welding control method according to claim 3, wherein the welding current and the welding voltage have pulse waveforms, and using an electromagnetic pinch force by the pulses, the droplet is detached.

5. The welding control method according to claim 3, wherein CO₂ gas is used for a shielding gas.
